(19) United States
(12) Patent Application Publication
(10) Pub. No.: US 2019/0037030 A1
(43) Pub. Date: Jan. 31, 2019

(54) Method for Pairing Internet-of-Things Devices to Cloud Services

(71) Applicant: Siemens Aktiengesellschaft, Muenchen (DE)

(72) Inventors: Elisabeth Heindl, Cadolzburg (DE); Gerald KAEFER, Muenchen (DE); Wolfgang RIEDL, Nuernberg (DE)

(21) Appl. No.: 16/044,826

(22) Filed: Jul. 25, 2018

(30) Foreign Application Priority Data
Jul. 25, 2017 (EP) 17183062.3

(51) Int. Cl. H04L 29/08; G06F 3/16; H04L 29/06

(52) U.S. Cl. CPC H04L 67/141; H04L 67/12; H04L 63/0471; H04L 67/148; G06F 3/16; H04L 67/10

(57) ABSTRACT

A method for connecting an Internet-of-Things device to a cloud service, wherein establishment of contact to a cloud service occurs via a contact device that includes an apparatus for detecting image and/or acoustic information which is orientated such that an apparatus for emitting optical and/or acoustic signals of the Internet-of-Things device is detectable optically and/or acoustically, transfer of device information of the Internet-of-Things device to an onboarding service of the cloud service is achieved via the apparatus for emitting the optical and/or acoustic signals and via the contact device, transfer of network configuration data to the onboarding service of the cloud service is performed via the contact device, a pairing connectivity file is created by the onboarding service, transfer of the pairing connectivity file to the Internet-of-Things device occurs via the contact device, and creation of the connection occurs from the Internet-of-Things device to the cloud service.

### BACKGROUND OF THE INVENTION

### 1. Field of the Invention

The invention relates to a method for connecting an Internet-of-Things device to a cloud service and an associated connection system for connecting the Internet-of-Things device to the cloud service.

### 2. Description of the Related Art

In the context of a digitization of industrial plants, field devices are ever more frequently connected to cloud services that are typically operated via the Internet. Reference is also made in this regard to an Internet-of-Things (IoT) device in order to specify the field device more precisely. The industrial context involves a sensitive environment. Consequently, different auto-configuration mechanisms that are known from a home automation environment are not applicable in this setting.

A first requirement that must be fulfilled for the digitization of the field devices is a transfer of configuration information, in particular a (local) network context and different data points from the cloud service to the field devices. This is necessary because the local network context, such as DHCP information, information of a proxy server or 10 addresses and the data points are often different for each field device within an industrial, technical installation.

A second requirement lies, for safety reasons, in opening as few interfaces of the connection of the field device or the Internet-of-Things device to the cloud service for the transfer of the configuration information.

In addition, the hardware costs for the connection between the field device or the Internet-of-Things device and the cloud service are to be minimized.

Finally, an operation of the field device or the Internet-of-Things device and the creation of the connection of the field device or the Internet-of-Things device to the cloud service should be configured as simply as possible.

In the environment of the MindSphere® Software as a Service (SaaS) solution, Internet-of-Things devices have previously been connected to a cloud service in accordance with the following method:
a) The network context, in particular DHCP information, information of a proxy server or 10 addresses and data points are determined by a local IT administrator after the IT administrator has established a connection network belonging thereto;
b) In a software portal of the MindSphere® SaaS solution invoked via a contact device separate from the Internet-of-Things device, an onboarding service of the cloud service is started, where configuration information of the Internet-of-Things device, the device being identified by means of a device number, is communicated to the onboarding service;
c) Subsequently, the onboarding service of the cloud service generates a pairing connectivity file that comprises information regarding the connection between the Internet-of-Things device and the cloud service as well as a machine certificate of the Internet-of-Things device;
d) The pairing connectivity file is transferred via the contact device to a USB stick and the USB stick is connected to the Internet-of-Things device;
e) The Internet-of-Things device reads the information stored on the USB stick and compares the information with a certificate stored on the Internet-of-Things device and accepts the configuration information if the information is valid.
f) Lastly, the connection between the Internet-of-Things device and the cloud service is created.

When the connection of the Internet-of-Things device to the cloud service has been successfully established, this is indicated via two status LEDs mounted on the Internet-of-Things device which glow green. If the connection has not come about, this is shown, for example, via a yellow/orange/red coloring. Error detection is not easy to bring about due to the limited representation of information. In addition, an error diagnosis is made more difficult in that the Internet-of-Things device is not in the same network context at the time point of the generation of the pairing connectivity file as the contact device and the cloud service, such that any network diagnosis means of the contact device cannot be used for an error search.

In order to be able to perform a detailed diagnosis, conventionally, log files of the Internet-of-Things device have had to be transferred to a USB stick and subsequently analyzed by an IT administrator on an external device. This type of diagnosis is time-consuming and ties up personnel resources because an IT administrator or a comparably qualified specialist must always be present at the Internet-of-Things device in order to be able to identify possible error sources, such as errors on the communication of configuration information.

### SUMMARY OF THE INVENTION

In view of the foregoing, it is therefore an object of the invention to provide a method for connecting an Internet-of-Things device to a cloud service that enables an automated error search in the event of connection problems between the Internet-of-Things device and the cloud service.

This and other objects and advantages are achieved in accordance with the invention by a method for connecting an Internet-of-Things device to a cloud service and by a connecting system for connecting the Internet-of-Things device to a cloud service where the Internet-of-Things device has an apparatus for emitting optical and/or acoustic signals, in particular at least one light-emitting diode and/or a loudspeaker and the cloud service has an onboarding service that is configured to accept inquiries of the Internet-of-Things device. The inventive method comprises the following method steps:
a) establishment of contact to the cloud service via a contact device configured therefor, in particular a personal computer or a mobile device that comprises an apparatus for detecting image information and/or acoustic information, in particular a camera and/or a microphone;
b) orientation of the apparatus for acquiring image information and/or acoustic information such that the device for emitting optical and/or acoustic signals of the Internet-of-Things device is detectable optically and/or acoustically by the apparatus for acquiring image information and/or acoustic information of the contact device;
c) transfer of device information of the Internet-of-Things device via the apparatus for emitting optical and/or acoustic signals and via the contact device to the onboarding service of the cloud service, where the onboarding service stores the transferred device information automatically in a special device configuration store;
d) transfer of network configuration data to the onboarding service of the cloud service via the contact device;
e) creation of a pairing connectivity file by the onboarding service, where the pairing connectivity file preferably comprises information regarding a connection of the Internet-of-Things device to the cloud service and a machine certificate of the Internet-of-Things device;
f) transfer of the pairing connectivity file to the Internet-of-Things device via the contact device; and
g) creation of the connection from the Internet-of-Things device to the cloud service.

The inventive method provides that information items, in particular connection information and error information is exchanged between the Internet-of-Things device and the cloud service via the optical and/or acoustic interface of the Internet-of-Things and a suitably configured corresponding interface of the contact device.

In an advantageous embodiment of the method, a connection status of the Internet-of-Things device to the cloud service is monitored via an internal process of the Internet-of-Things device, where in the event of an error, a diagnosis process is started that checks the connection and generates a specific error message code that is subsequently transferred via the apparatus for emitting optical and/or signals to the contact device and from this to the onboarding service.

A possible error source can lie therein that an IPV4 connection has not come about. The diagnosis process can conclude therefrom that the error source lies in the network configuration. With the optical and/or acoustic interface of the Internet-of-Things device, subsequently thereto, the diagnosis process can transfer the error cause with an exact error message, in this case the error message of an IP protocol stack, to the contact device and thus indirectly to the cloud service. Herein, the diagnosis process of the specific error message code which is known to the cloud service is made use of. A specialist can access suitable measures via remote diagnosis or remote servicing without needing to be present on location at the Internet-of-Things device. The error diagnosis can herein occur not just by the cloud service, but also directly at the contact device.

Advantageously, a user of the contact device has himself authorized in relation to the cloud service before the start of the connecting method, where a type of the Internet-of-Things device that is connectable to the cloud service is dependent thereon, where the authorization level has previously been assigned to the user. For example, access to all Internet-of-Things devices can be assigned to a qualified specialist, whereas a less qualified specialist receives only authorizations for the particular types of devices. In this way, a reliable and simply realizable access control to the cloud service is possible.

In an advantageous embodiment of the invention, after receiving the pairing connectivity file, the Internet-of-Things device undertakes an authorization check of the pairing connectivity file, for example, based on a comparison of a machine certificate contained in the pairing connectivity file with a corresponding certificate stored in the Internet-of-Things device. With this, the Internet-of-Things device can ensure that it has become connected to the correct cloud service.

The pairing connectivity file can advantageously initially be transferred from the onboarding service to the contact device and subsequently be transferred via a portable storage medium, in particular a USB stick, from the contact device to the Internet-of-Things device. The transfer of the pairing connectivity file via the USB stick represents a particularly reliable transfer method.

Preferably, in the context of the transfer of device information of the Internet-of-Things device via the contact device to the onboarding service of the cloud service (method step c of the inventive method), the following method steps are performed:
i) The Internet-of-Things device transfers device information via the apparatus for emitting optical and/or acoustic signals to the apparatus for acquiring image information and/or acoustic information of the contact device;
ii) The device information is transferred to a pairing service of the contact device;
iii) The pairing service of the contact device transfers a unique password to the Internet-of-Things device, in particular via a wireless connection, preferably WLAN;
iv) With the password, the Internet-of-Things device encrypts the device information and sends it anew via the apparatus for emitting optical and/or acoustic signals to the pairing service of the contact device;
v) The pairing service decrypts the encrypted device information contained by the Internet-of-Things device;
vi) The pairing service communicates the decrypted device information of the Internet-of-Things device to the onboarding service of the cloud service.

Through the optical and/or acoustic transfer of the unique password via the optical and/or acoustic interface of the Internet-of-Things device and the corresponding receiver of the contact device, it is possible to insure the Internet-of-Things device is authorized to establish a connection with the cloud service. On the basis of the absolutely necessarily direct optical and/or acoustic coupling of the Internet-of-Things device and the contact device, an IT administrator or a comparably qualified specialist must always be present on site when the connection is established, which increases safety. Furthermore, the Internet-of-Things device thereby knows that it is connecting to the correct cloud service. A transfer of the pairing connectivity file from the cloud service to the Internet-of-Things device via a USB stick is thus no longer necessary, but can be undertaken additionally in order to provide a safety technology redundancy.

It is also an object to provide a connection system comprising an Internet-of-Things device with an apparatus for emitting optical and/or acoustic signals which is configured to transfer information via the apparatus for emitting optical and/or acoustic signals, a contact device with an apparatus for acquiring image information and/or acoustic information and a cloud service with an onboarding service, where the contact device is configured to establish a connection to the onboarding service of the cloud service.

In a preferred embodiment, the contact device of the connection system comprises a pairing service that is configured to encrypt and decrypt data received from the Internet-of-Things device.

In the context of a preferred use, the connection system can be used to operate a technical installation.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The above-described properties, features and advantages of this invention and the manner in which these are achieved will now be described more clearly and explicitly with the following description of the exemplary embodiments, and by reference to the drawings, in which:

FIG. 1 is a schematic block diagram of a prior art connection system;

FIG. 2 is a schematic block diagram of a connection system in accordance with the invention; and

FIG. 3 is a flowchart of the method in accordance with the invention.

### DETAILED DESCRIPTION OF THE EXEMPLARY EMBODIMENTS

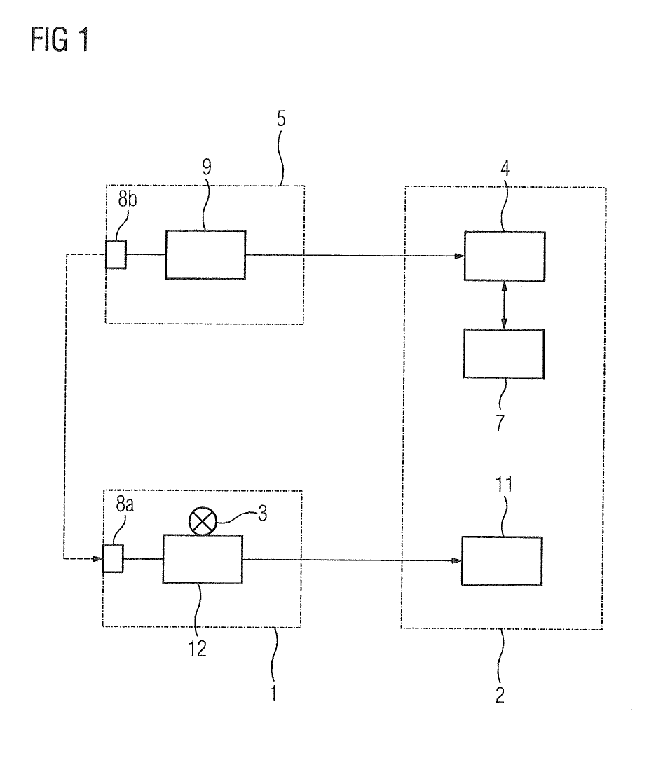

FIG. 1 shows a connection system, for example, of a technical installation. The connection system comprises an Internet-of-Things device 1, a contact device 5 and a cloud service 2.

The Internet-of-Things (IoT) device 1 can be, for example, a field device of an industrial, technical installation and has an interface 8a for a mobile storage medium, in particular a USB stick. Furthermore, the Internet-of-Things device 1 comprises an apparatus for emitting optical and/or acoustic signals 3 in the form of a status LED and a central control unit 12, such as a microprocessor.

The contact device 5 also comprises an interface 8b for a mobile storage medium, in particular a USB stick. The contact device 5 can be, for example, a personal computer or a mobile device, such as a tablet.

The cloud service 2 comprises an onboarding service 4, a device configuration store 7 and an IoT device data transfer service 11. The cloud service 2 can be operated, for example, in the environment of the MindSphere® SaaS solution developed by Siemens.

The Internet-of-Things device 1 is connected to a cloud service 2 in the environment of MindSphere® in accordance with the following method:
a) The network context, in particular Dynamic Host Configuration Protocol (DHCP) information, information of a proxy server or 10 addresses and data points are determined by a local IT administrator once the IT administrator has established a connection network belonging thereto;
b) In the contact device 5, the onboarding service 4 of the cloud service 2 is started via a software portal of a pairing service 9 integrated into the contact device 5, where configuration information of the Internet-of-Things device 1, said device being identified via a device number, is communicated to the onboarding service 4;
c) Subsequently, the onboarding service 4 of the cloud service 2 generates a pairing connectivity file that comprises information regarding the connection between the Internet-of-Things device 1 and the cloud service 2 as well as a machine certificate of the Internet-of-Things device 1;
d) The pairing connectivity file is transferred via the contact device 5 via the USB interface 8b to a USB stick and the USB stick is connected by means of the corresponding USB interface 8a to the Internet-of-Things device 1 (the transfer of the pairing connectivity file via the USB stick is represented as a dashed connection between the two USB interfaces 8a, 8b);
e) The Internet-of-Things device 1 reads the information stored on the USB stick and compares the information with a certificate stored on the Internet-of-Things device 1 and accepts the configuration information if it is valid.
f) Finally, a connection is created between the Internet-of-Things device 1 and the IoT device data transfer service 11 of the cloud service 2 in order to be able to exchange data between the Internet-of-Things device 1 and the cloud service 2.

When the connection between the Internet-of-Things device 1 and the IoT device data transfer service 11 of the cloud service 2 has been successfully established, this is indicated by the status LED 3 which in this case glows green. If the connection has not come about, this is shown, for example, via a yellow, orange or red coloring of the status LED 3.

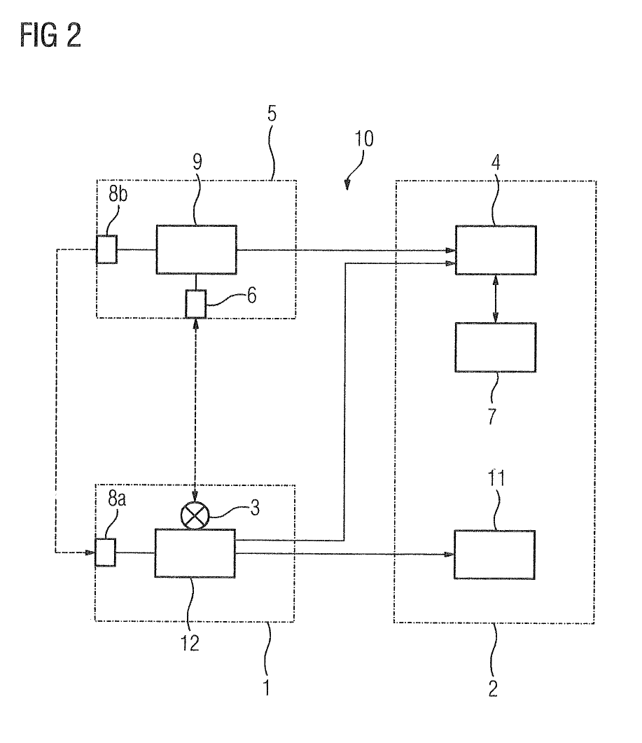

FIG. 2 shows a connection system 10 in accordance with the invention. The connection system 10 comprises an Internet-of-Things device 1, a contact device 5 and a cloud service 2.

The Internet-of-Things device 1 can be, for example, a field device of an industrial, technical installation and comprises an interface 8a for a mobile storage medium, in particular a USB stick. Furthermore, the Internet-of-Things device 1 comprises an apparatus for emitting optical and/or acoustic signals 3 in the form of an LED and a central control unit 12, such as a microprocessor. The central control unit 12 is configured and provided to communicate information codes optically via the LED 3.

The contact device 5 also comprises an interface 8b for a mobile storage medium, in particular a USB stick. The contact device 5 can be, for example, a personal computer or a mobile device, such as a tablet. A pairing service 9 is integrated into the contact device. In contrast to the conventional connection system, the contact device 5 in the inventive connection system 10 represented in FIG. 2 also comprises an apparatus for acquiring image information and/or acoustic information 6 in the form of a camera.

The cloud service 2 is configured similarly to the connection system illustrated in FIG. 1 and comprises an onboarding service 4, a device configuration store 7 and an IoT device data transfer service 11. The cloud service 2 can be operated, for example, in the environment of the MindSphere® SaaS solution developed by Siemens.

A connection of the Internet-of-Things device 1 to the cloud service 2 is constructed as follows.

With the pairing service 9 of the contact device 5, in particular a personal computer or a mobile device, a user makes contact with the cloud service 2. This can occur, for example, by invoking a special software portal. The user of the contact device 5 has himself authorized in relation to the cloud service 2, where a type of the Internet-of-Things device 1 that is to be connected by the user to the cloud service 2 is dependent thereon, where the authorization level has been assigned to the user in advance.

Following successful authorization, the camera 6 of the contact device 5 is oriented such that it can acquire optical information from the LED 3 of the Internet-of-Things device 1. Subsequently, device information of the Internet-of-Things device 1 is transferred via the LED 3 to the camera 6 of the contact device 5. The device information is communicated to the pairing service 9 of the contact device 5. The pairing service 9 of the contact device 5 transfers a unique password to the Internet-of-Things device 1, in particular via a wireless connection, preferably WLAN. It is also possible to exchange the unique password via a USB stick between the contact device 5 and the Internet-of-Things device 1.

With the unique password, the Internet-of-Things device 1 then encrypts the device information and sends it anew via the LED 3 to the pairing service 9 of the contact device 5. The pairing service 9 decrypts the encrypted device information contained by the Internet-of-Things device 1 and subsequently communicates the decrypted device information of the Internet-of-Things device 1 to the onboarding service 4 of the cloud service 2.

The device information transferred via the contact device 5 to the onboarding service 4 of the cloud service 2 is finally placed automatically in the special device configuration store of the cloud service 2.

Thereafter, the onboarding service 4 generates a pairing connectivity file that preferably comprises information regarding a connection of the Internet-of-Things device 1 to the cloud service 2 and a machine certificate of the Internet-of-Things device 1. The pairing connectivity file is thereafter transferred to the Internet-of-Things device 1 via the contact device 5.

The pairing connectivity file can be transferred, for example wirelessly, to the Internet-of-Things device 1. The pairing connectivity file can, however, also be transferred via a portable storage medium 8a, 8b, in particular a USB stick, from the contact device 5 to the Internet-of-Things device 1. Following the receipt of the pairing connectivity file, the Internet-of-Things device 1 undertakes an authenticity check of the pairing connectivity file, preferably based on a comparison of a machine certificate contained in the pairing connectivity file with a corresponding certificate stored in the Internet-of-Things device 1.

Finally, a connection of the Internet-of-Things device 1 to the IoT device data transfer service 11 of the cloud service 2 is created.

A connection status of the Internet-of-Things device 1 to the cloud service 2 or to the IoT device data transfer service 11 is herein monitored by an internal process that is implemented on the control unit 12 of the Internet-of-Things device 1. In the event of an error, a diagnosis process is started that checks the connection and generates a specific error message code. This is subsequently transferred via the LED 3 to the contact device 5 and therefrom to the onboarding service 4 of the cloud service 2 in order to be able to perform a qualified and simple error search.

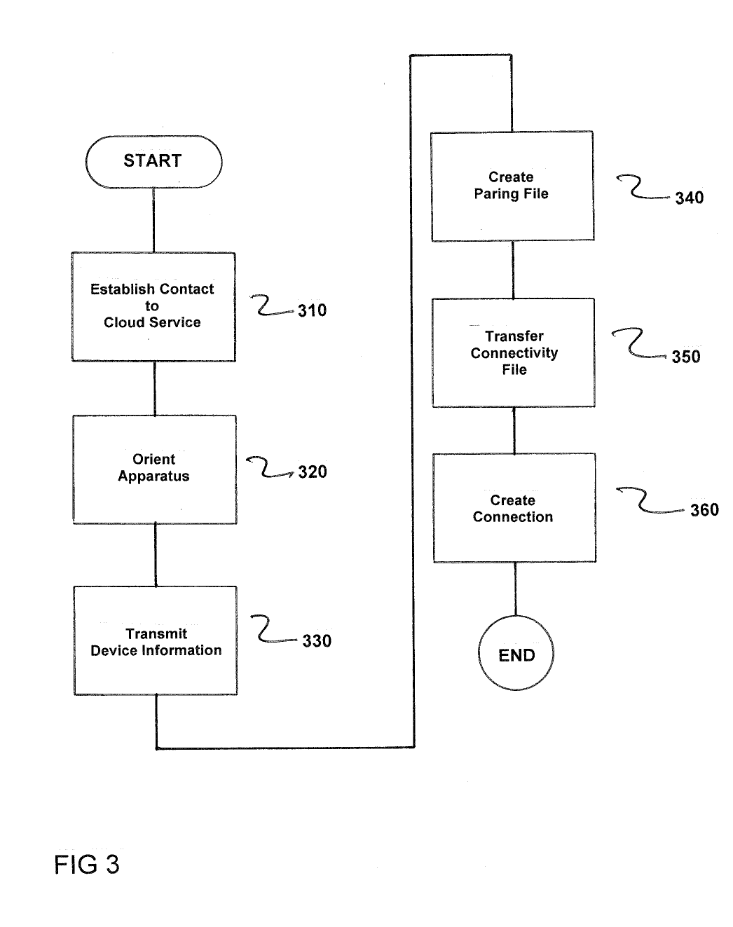

FIG. 3 is a flowchart of a method for connecting an Internet-of-Things device 1 to a cloud service 2, where the Internet-of-Things device 1 includes an apparatus for emitting at least one of (i) optical 3 and (ii) acoustic signals 3, and the cloud service 2 comprises an onboarding service 4 that is configured to accept inquiries of the Internet-of-Things device 1. The method comprises establishing contact to the cloud service 2 via a contact device 5 configured to contact the cloud service 2, as indicated in step 310.

Next, the apparatus is oriented to acquire at least one of (i) image information and (ii) acoustic information 6 such that the device for emitting at least one of the (i) optical 3 and (ii) acoustic signals 3 of the Internet-of-Things device 1 is detectable at least one of (i) optically and (ii) acoustically by the apparatus for acquiring at least one of (i) the image information and (ii) the acoustic information 6 of the contact device 5, as indicated in step 320.

Next, device information of the Internet-of-Things device 1 is transmitted to the onboarding service 4 of the cloud service 2, via the apparatus for emitting at least one of (i) the optical 3 and (ii) the acoustic signals 3 and via the contact device 5, as indicated in step 330. Here, the onboarding service 4 automatically stores the transferred device information in a device configuration store 7.

Next, a pairing connectivity file comprising information regarding a connection of the Internet-of-Things device 1 to the cloud service 2 and a machine certificate of the Internet-of-Things device 1 is created by the onboarding service (4), as indicated in step 340.

The pairing connectivity file to the Internet-of-Things device 1 is now transferred by the contact device 5, as indicated in step 350.

Next, the connection from the Internet-of-Things device 1 to the cloud service 2 is created, as indicated in step 360.

Although the invention has been illustrated and described in detail with the preferred exemplary embodiment, the invention is not restricted by the examples given and other variations can be derived therefrom by a person skilled in the art without departing from the protective scope of the invention.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for connecting an Internet-of-Things device to a cloud service, the Internet-of-Things device having an apparatus for emitting at least one of (i) optical and (ii) acoustic signals, and the cloud service comprising an onboarding service which is configured to accept inquiries of the Internet-of-Things device, the connecting method comprising:
a) establishing contact to the cloud service via a contact device configured to contact the cloud service;
b) orienting the apparatus to acquire at least one of (i) image information and (ii) acoustic information such that the device for emitting at least one of the (i) optical and (ii) acoustic signals of the Internet-of-Things device is detectable at least one of (i) optically and (ii) acoustically by the apparatus for acquiring at least one of (i) the image information and (ii) the acoustic information of the contact device;
c) transferring, via the apparatus for emitting at least one of (i) the optical and (ii) the acoustic signals and via the contact device, device information of the Internet-of-Things device to the onboarding service of the cloud service, the onboarding service automatically storing the transferred device information in a device configuration store;
d) creating, by the onboarding service, a pairing connectivity file comprising information regarding a connection of the Internet-of-Things device to the cloud service and a machine certificate of the Internet-of-Things device;
e) transferring, by the contact device, the pairing connectivity file to the Internet-of-Things device; and
f) creating the connection from the Internet-of-Things device to the cloud service.

2. The method as claimed in claim 1, wherein a connection status of the Internet-of-Things device to the cloud service is monitored via an internal process of the Internet-of-Things device; wherein in an event of an error, a diagnosis process is started which checks the connection and generates a specific error message code which is subsequently transferred via the apparatus for emitting at least one of (i) the optical and (ii) the acoustic signals to the contact device and from the contact device to the onboarding service.

3. The method as claimed in claim 1, wherein a user of the contact device is authorized in relation to the cloud service prior to a start of the connecting method; and wherein a type of the Internet-of-Things device which is connectable by the user to the cloud service is dependent thereon at which an authorization level has been assigned to the user in advance.

4. The method as claimed in claim 1, wherein, following the receipt of the pairing connectivity file, the Internet-of-Things device performs an authenticity check of the pairing connectivity file based on basis a comparison of a machine certificate contained in the pairing connectivity file with a corresponding certificate stored in the Internet-of-Things device.

5. The method as claimed in claim 1, wherein the pairing connectivity file is initially transferred from the onboarding service to the contact device and is subsequently transferred via a portable storage medium.

6. The method as claimed in one claim 1, wherein, during transference of the device information of the Internet-of-Things device via the contact device to the onboarding service of the cloud service pursuant to step c), the method further comprises:
i) transferring, by the Internet-of-Things device, the device information via the apparatus for emitting at least one of (i) the optical and (ii) the acoustic signals to the apparatus for acquiring at least one of (i) the image information and (ii) the acoustic information of the contact device;
ii) transferring the device information to a pairing service of the contact device;
iii) transferring, by the pairing service of the contact device, a unique password to the Internet-of-Things device via a wireless connection comprising a WLAN;
iv) encrypting the device information, by the Internet-of-things device via the unique password and resending the device information via the apparatus for emitting at least one of (i) the optical and (ii) the acoustic signals to the pairing service of the contact device;
v) decrypting, by the pairing service, the encrypted device information contained by the Internet-of-Things device; and
vi) communicating, by the pairing service, the decrypted device information of the Internet-of-Things device to the onboarding service of the cloud service.

7. The method as claimed in claim 1, wherein the apparatus for emitting at least one of (i) optical and (ii) acoustic signals comprises at least one of (i) at least one light-emitting diode and (ii) a loudspeaker.

8. The method as claimed in claim 1, wherein the contact device configured to contact the cloud service comprises one of (i) a personal computer and (ii) a mobile device which comprises an apparatus for detecting at least one of (i) image information and (ii) acoustic information.

9. The method as claimed in claim 8, wherein the apparatus for detecting at least one of (i) image information and (ii) acoustic information comprises at least one of a camera and a microphone.

10. A connection system for connecting an Internet-of-Things device to a cloud service, comprising:
an Internet-of-Things device including an apparatus for at least one of (i) emitting optical and (ii) acoustic signals which is configured to transfer information via the apparatus for emitting at least of (i) the optical and acoustic signals;
a contact device including an apparatus for acquiring at least one of (i) image information and (ii) acoustic information; and
a cloud service including an onboarding service;
wherein the contact device is configured to establish a connection to the onboarding service of the cloud service.

11. The connection system as claimed in claim 10, wherein the contact device comprises a pairing service which is configured to encrypt and decrypt data received from the Internet-of-Things device.

12. The connection system as claimed in claim 10, wherein a technical installation is operated by the connection system).

13. The connection system as claimed in claim 11, wherein a technical installation is operated by the connection system.
